(19) United States
(12) Patent Application Publication
(10) Pub. No.: US 2026/0370077 A1
(43) Pub. Date: Nov. 19, 2026

(54) STRIP CONDUCTOR DEVICE DESIGNED FOR USE IN ELECTRICAL MACHINES, IN PARTICULAR MOTORS, SUPPLIED WITH ALTERNATING CURRENT

(71) Applicant: ADDITIVE | DRIVES GMBH, Dresden (DE)

(72) Inventor: Axel HELM, Dresden (DE)

(21) Appl. No.: 19/132,168

(22) PCT Filed: Dec. 5, 2023
(86) PCT No.: PCT/EP2023/084214

§ 371 Date: May 22, 2025

(30) Foreign Application Priority Data
Dec. 5, 2022 (DE) 10 2022 132 247.5

(51) Int. Cl. H02K 3/34; H02K 3/02; H02K 3/14; H02K 15/0421

(52) U.S. Cl. CPC H02K 3/34; H02K 3/02; H02K 3/14; H02K 15/0421

(57) ABSTRACT

Disclosed are electric machines supplied with alternating current, including at least two elongated, rigid strip conductor elements with contact devices for coupling to and decoupling from electric current. The strip conductor elements are stacked on top of one another and exchange their positions relative to their position in the stack at least once over their conductor length in the course of a full transposition distance. This position exchange can be achieved without twisting or rotation via complementary step increments of the strip conductor elements, brought about by means of material deformation.

The invention relates to a strip conductor device designed for use in electrical machines, in particular motors, supplied with alternating current, comprising at least two elongated, in particular rigid, strip conductor elements with contact devices for coupling to and decoupling from electrical current, wherein the strip conductor elements provide a current path and the strip conductor elements form a layer arrangement with electrical insulation located therebetween, according to the preamble of claim 1.

It is known to use so-called Roebel conductors in high-current applications in generators or in powerful electric motors.

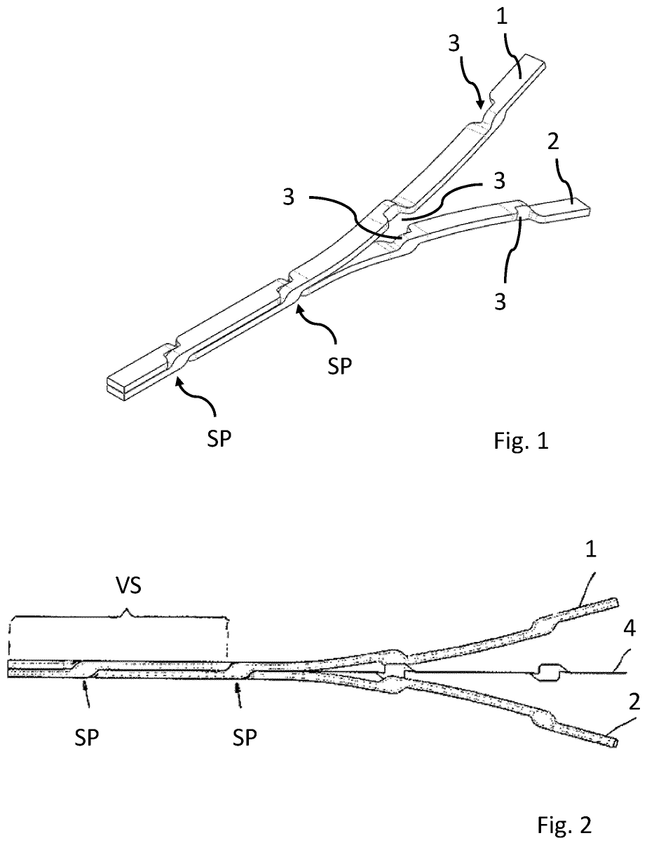

Roebel conductors or Roebel bars usually consist of several individual conductors which exchange their positions over the conductor length in the course of a full transposition length (for the term full transposition length, see in particular DE 10 2012 218 986A1 , FIGS. 1 and 2, ‘V’, as well as the associated description) once (so that each individual conductor returns to its original position after the exchange, only further along the length of the Roebel conductor). This causes each partial conductor to change its position in a wound coil. This is particularly important in terms of minimising alternating current losses and reducing coupling losses. A Roebel conductor typically extends over many full transposition lengths and is capable of carrying high currents due to a large number of Roebelised individual conductors.

When winding round coils, the permanent exchange of the positions of the individual conductors over the conductor length ensures that a conductor temporarily runs on the inside, i.e. at a smaller winding radius, and then again on the outside, i.e. at a larger winding radius.

DE 39 23 310 C1 shows an exemplary method for manufacturing Roebel rods.

Roebel rods are rods produced by twisting square profile wires. The profile wires can be brought together in the Roebel tool in such a way that sections with untwisted, parallel profile wires and sections with twisted profile wires are continuously lined up next to each other and that each time the foremost strand section in the untwisted region is periodically separated from the strand as a Roebel rod.

A double Roebel rod for winding an electric machine is known from DE 197 54943A1. There, partial conductors are arranged in four adjacent stacks. Two adjacent partial conductors each are guided side by side over the entire length of a conductor as a partial conductor pair and are twisted in the process. For a desired twist, the partial conductors are offset both parallel as well as crossed to achieve optimal compensation of the transverse and radial fields of an electric machine in operation.

CH 15177 A discloses a device for manufacturing interlocked flat conductors. In the grooves of the stator irons of an electric alternating current machine, rods, layered from several interlocked flat conductors, of a coil are lying. After exiting from the groove free rod ends extend axially to the base of end windings.

WO 2022/029008A1 , originating from the applicant, relates to a method for the additive manufacture of a three-dimensional component with at least one electrical conductor, in particular with at least one conductor winding, preferably a coil, preferably a hairpin for an electrical machine, in particular an electric motor or generator. The electrical conductor is realised by layer-by-layer application of a build-up material and locally selective solidification of the build-up material by an irradiation with a beam impinging on the build-up material in such a way that the conductor comprises first regions and at least one second region, wherein the first regions are separated in a cross-section perpendicular to the longitudinal direction of the conductor at least partially by the at least one second region. The at least one second region has a lower conductivity than the first regions. With the regions with different conductivity structures can be created during additive manufacturing in an easy manner that positively influence the flow of current, in particular reducing eddy current effects.

However, it has been shown that, in addition to the many advantages of additive manufacturing of conductor structures, the manufacturing process is very time-consuming, which stands in the way of mass production or an increase in productivity in the manufacture of such windings or coils.

Based on the above mentioned, the object of the invention is to provide an advanced strip conductor device designed for use in electrical machines supplied with alternating current, in particular electric motors. The strip conductor device should be inexpensive and highly efficient to manufacture and, in addition, have further improved electrical properties compared to the prior art, in particular reduced losses due to the skin effect, and contribute to achieving high fill factors.

The strip conductor device comprising strip conductor elements is based on the idea of manufacturing the individual strip conductor elements separately and being able to process them using conventional methods, such as massive forming or pressing, in order to ensure the high productivity mentioned above. The manufactured strip conductor elements can then be joined to form the strip conductor device, cut to length as required and connected at the ends.

The object of the invention is achieved in particular by the combination of features according to claim 1, wherein the dependent claims represent at least advantageous embodiments and further developments.

Accordingly, the invention in particular starts at a strip conductor device which is designed for use in electric machines supplied with alternating current, in particular electric motors.

The strip conductor device has at least two elongated, rigid strip conductor elements with contact devices for coupling to and decoupling from electrical current, wherein the strip conductor elements provide a current path.

The strip conductor elements form a layer arrangement with electrical insulation between them.

In particular, separately manufactured strip conductor elements can be provided with a completely enclosing insulation and are stacked on top of each other subsequently.

Generally, therefore, a stacking of at least two strip conductor elements on top of each other occurs. The strip conductor elements exchange their positions relative to the position in the stack, i.e. top or bottom, at least once over their conductor length, in particular in the course of a full transposition distance.

This position exchange is achieved free of twisting or rotation by means of complementary step increments of the strip conductor elements, brought about by material deformation.

Preferably, in particular in order to achieve a compact structure, the cross-sectional shapes of the strip conductor elements vary in the region of the step increments.

In the region of the step increments, upon varying cross-sectional shape the cross-sectional area is preferably at least largely the same. Due to the desired constant cross-sectional area hot spots in the strip conductor device are prevented or minimised.

In addition, by the geometric surface shape a frequency adjustment with regard to the aforementioned use in electric machines supplied with alternating current, in particular motors, can be achieved.

In further development of the invention, the cross-sectional area (at at least one cross-section, possibly at all cross-sections) in the region of the step increments or in the region of at least one step increment (and/or in the region of at least one recess, in particular a recess on the width side of the strip conductor element) is adapted to the cross-sectional area of the remaining sections of the strip conductor elements (in particular, at least at one cross-section of the step increment, at least essentially equal to a cross-sectional area of at least one remaining, if applicable all remaining, sections of the strip conductor elements not lying within a step increment). Preferably, a high degree of uniformity and consistency of the cross-sectional areas is to be achieved.

The step increments preferably each have complementary recesses on the width side of the strip conductor elements, which preferably interlock as a result of the stack being joined together (and in particular thus create the desired compact arrangement).

The stack arrangement of the strip conductor device preferably comprises at least two strip conductor elements, each with at least one or at least two step increments, wherein the respective ends of the strip conductor elements are electrically connected.

The stack arrangement is preferably adapted in terms of its measurements in length and cross-section to the dimensions of grooves in the stator or core of an electric machine.

In a preferred embodiment, the strip conductor device is part of a rectangular coil or forms so-called hairpins of electrical machines.

In embodiments, the strip conductor device can only be provided in a subset of a number of individual pins (hairpins) of a coil and/or electrical machine (or in all pins). For example, the strip conductor device can be provided in at least 1%, preferably at least 8%, further preferably at least 25% and/or at most 90%, preferably at most 70%, further preferably at most 50% of the pins. By this the advantages of the strip conductor device can be used in a targeted and measured manner. Preferably, pins located further inside a respective stator are equipped with the strip conductor device, and pins located further outside are not.

The strip conductor elements are stacked preferably flatly narrowly and/or at least almost gap-free and/or densely, as well as with intermediate arrangement of a thin insulating layer.

The insulating layer can be introduced between opposite surface sides of the strip conductor elements in a continuous process when joining the strip conductor elements to form the strip conductor device.

This represents an alternative or addition to the also possible full-surface (an insulating layer forming) envelopment of the individual strip conductor elements prior to joining the strip conductor device.

The thickness (d1) or (or rather) the layer thickness of the insulating layer is many times smaller than the thickness (d2) of the strip conductor elements (e.g.: d1≤0.5*d2 or d1≤0.1*d2 or d1≤0.05*d2 and/or d1≥0.001*d2 or d1≥0.005*d2). The thickness or the layer thickness of the insulating layer can be made extremely small due to the low potential differences between the strip conductor elements, so that the desired compact design of the strip conductor device with a correspondingly high filling factor is achieved for the intended use.

The strip conductor elements are, for example, of a solid copper or copper alloy material and/or of a solid aluminium or aluminium alloy material and/or are produced by means of additive manufacturing technology.

The strip conductor elements can be produced by material deformation. For example, solid strip materials with a preferably rectangular cross-section can be formed, preferably in such a way that one or several step increments are formed. The joining of the strip conductor elements to obtain the strip conductor device can be carried out automatedly.

A production of the strip conductor device, in particular if it forms or comprises a hairpin geometry, can occur conventionally, in particular comprising a bending and/or a welding. In general, this may be a (simple) replacement of hairpins with the present strip conductor device.

The strip conductor elements of the strip conductor device are preferably arranged (in cross-section, in particular perpendicular to the longitudinal extension) (at least outside the respective step increment or the respective step increments and/or outside of at least one recess, in particular a recess on the width side of the strip conductor element) and/or over at least 50% or at least 90% of their length) in (only) one row one above the other. In contrast to, for example, a Roebel rod, in which at least two rows are arranged next to each other, by this space can be saved.

The strip conductor elements of the strip conductor device are preferably arranged (in cross-section, in particular perpendicular to the longitudinal extension) (at least outside the respective step increment or the respective step increments and/or outside of at least one recess, in particular a recess on the width side of the strip conductor element, and/or over at least 50% or at least 90% of their length) in such a way that they do not lie next to each other. In contrast to, for example, a Roebel rod, in which (in cross-section) at least two rows are always arranged next to each other, by this space can be saved.

The strip conductor elements of the strip conductor device can run in the same direction (at least outside the respective step increment or the respective step increments and/or outside of at least one recess, in particular a recess on the width side of the strip conductor element, and/or over at least 50% or at least 90% or at least 95% of their length).

The respective centre lines of the strip conductor elements of the strip conductor device can (at least outside the respective step increment or the respective step increments and/or outside of at least one recess, in particular a recess on the width side of the strip conductor element, and/or over at least 50% or at least 90% or at least 95% of their length) be identical in a vertical projection onto a lower side of a lowest layer and/or an upper side of an uppermost layer (generally: outer side of an outermost layer).

The strip conductor device and/or the respective strip conductor may have at least or exactly two layers, or at least or exactly three layers, or at least or exactly four layers. The strip conductor device and/or the respective strip conductor may have at least one or exactly one, or at least two or exactly two, or at least four or exactly four, or more layer jump/layer jumps (step increment/step increments). At least or exactly two layer jumps (step increments) can together represent a transposition to the next but one (or, if there are a corresponding number of layer jumps/step increments, to the third layer or even further away) layer.

A (single) layer jump or step increment can lead (directly) from one layer to the next but one, or even further layer.

The strip conductor device can have at least two or exactly two, or at least three or exactly three, or more strip conductors.

The (respective) step increment (or layer jump) is preferably provided in a respective active area of the strip conductor or the strip conductor device. In general, at least one or exactly one, or at least two or exactly two, or at least three or exactly three, or more transpositions (layer jumps) may be present in the (respective) active area of a stator groove (per strip conductor device).

The (respective) step increment or step increments are preferably arranged in such a way that (maximum) suppression or reduction of eddy current and/or loop current losses within a total winding (total copper winding) is achieved.

Preferably, several step increments are arranged within the active area of the stator or motor at constant distances from each other.

The strip conductor device can be configured as a hairpin or as a replacement for (conventional) hairpins and/or within a profile wire winding, in particular to minimise eddy current losses within the winding.

The strip conductor device can be configured or used as alternatively or additionally to stranded wire.

The invention will be explained in more detail below with reference to an exemplary embodiment as well as with the aid of figures.

Hereby Show:

FIG. 1 a perspective view of a strip conductor device formed by joining two strip conductor elements according to the invention, which are already provided with an enveloping insulating layer;

FIG. 2 a side view similar to that of FIG. 1, but with an insulating layer embedded in the joining process of two strip conductor elements with step increments to produce the strip conductor device;

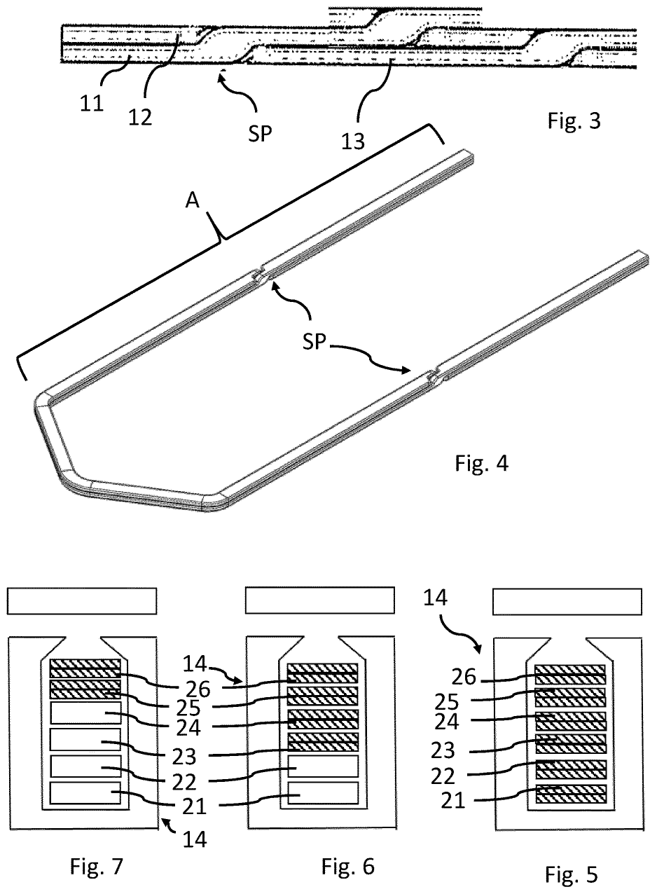

FIG. 3 a schematic side view of an alternative embodiment of a strip conductor device;

FIG. 4 a strip conductor device designed in a U-shape (to form a hairpin) in an oblique view;

FIG. 5 a schematic sectional view of a stator with strip conductor devices according to one embodiment;

FIG. 6 a representation analogous to FIG. 5 according to a further embodiment; and

FIG. 7 a representation analogous to FIG. 5 according to a further embodiment. The strip conductor device according to the figures consists of two strip conductor elements 1; 2, which are stacked on top of each other.

The strip conductor elements 1; 2 exchange their positions relative to their position in the stack over their conductor length in the course of a full transposition distance VS (see FIG. 2, where VS is shown schematically and ends at the beginning of the layer jump, which then completes the full transposition).

In the example shown, the strip conductor element 1 is located in the left-hand section according to FIG. 1 above and exchanges its position via a step increment SP to below.

The opposite is true for the strip conductor element (strip conductor section) 2, which exchanges its position from below via the step increment SP to above according to the figurative illustration in FIG. 1.

From the figurative illustration it can be seen that the positional exchange of the strip conductor elements is achieved without twisting or rotation via complementary step increments SP of the strip conductor elements, for example brought about by material deformation.

In the region of the step increments SP, the cross-sectional area shape of the strip conductor elements 1; 2 varies.

By shaping in the region of the step increments SP, it is possible with varying cross-sectional shapes to keep the cross-sectional area at least largely constant, so that current-induced hot spots can be avoided.

Preferably, a cross-sectional area of at least one cross-section (possibly all cross-sections) in the region of a (respective) step increment is at least 0.6 times, preferably at least 0.9 times and/or at most 1.5 times, preferably at most 1.1 times the cross-sectional area of at least one cross-section (possibly all cross-sections) of the respective strip conductor outside the step increment.

Preferably, a (minimum) width of a respective strip conductor in the region of a (respective) step increment is smaller than a width of the corresponding strip conductor outside the step increment, preferably by at least 10% or at least 30% smaller and/or by at most 80% smaller.

Preferably, a (maximum) thickness (height) of a respective strip conductor in the region of a (respective) step increment is greater than a thickness of the respective strip conductor outside the step increment, preferably by at least 10% or at least 50% greater and/or by at most 200% greater.

It is within the scope of the invention that the cross-sectional area in the region of the step increments SP is at least essentially adapted to the cross-sectional area of the remaining sections of the strip conductor elements 1; 2 and, if possible, is designed to be the same.

The step increments SP each have complementary 3 on the width side of the strip conductor elements, which interlock as a result of joining the gap (see FIG. 1).

As a result of joining the strip conductor elements 1; 2, preferably with a machine device, a strip conductor device is obtained, viewed from right to left in FIG. 1, with two strip conductor elements 1; 2, which are stacked flatly narrow, gap-free and densely, so that a compact arrangement is created.

In particular, if uninsulated strip conductor elements 1; 2 are used, a thin insulating layer 4 is inserted between the strip conductor elements 1; 2 during the process of stacking the strip conductor elements 1; 2 on top of each other (see FIG. 2).

This insulating layer 4 may be preformed with regard to the contour in the region of the step increments SP or may also consist of a material which, when the strip conductor elements 1; 2 are brought together and joined, takes on their shape in the region of the step increments.

The strip conductor elements 1; 2 can consist of solid copper or copper alloy material, which is advantageous for more effective and cost-efficient production. By Using material deformation methods known per se, which are preferably employed, and preferred, full area strip materials with a preferably rectangular cross-section can be formed in such a way that the step increments SP relevant here are formed and the joining of the strip conductor elements 1; 2 to obtain the strip conductor device can be carried out in a simple, automated manner.

A significant advantage of the strip conductor device presented exists due to the non-linear conductor structure with step increments in a reduction of the contact surface for a groove cross-field when the strip conductor device is used in electrical machines. Furthermore, current displacement is minimised. By a simple adjustment of the conductor geometry, it is possible to react to a different frequency spectrum during the operation of electrical machines. A possibly increased current density in the region of the step increment can be reduced by geometric adjustment and optimisation.

If the copper losses as a function of the conductor geometry based on known twisted conductor structures are compared with copper losses of the strip conductor device according to the invention, the frequency-dependent increase in losses when using a strip conductor device with a stacked arrangement of strip conductor elements and step increment, in particular at higher frequencies between 500 and 1500, possibly between 600 and 1000 Hertz, is significantly reduced.

FIG. 3 shows a schematic side view of an alternative embodiment of a strip conductor device. The strip conductor device comprises strip conductor elements 11; 12; 13, which form three layers and may have several step increments (for example, from a lowest or first layer shown in the figure to a middle or second layer and from there to a highest or third layer).

FIG. 4 shows a strip conductor device designed in a U-shape (to form a hairpin). Here it can be seen that only one transposition (layer jump) is provided in the respective active area A of the strip conductor. In general, at least one or exactly one, or at least two or exactly two, or at least three or exactly three, or more transpositions (layer jumps) may be present in the (respective) active area of a stator groove (per strip conductor device).

FIG. 5 shows a schematic sectional view of a stator 14 with a plurality of strip conductor devices 21; 22; 23; 24; 25; and 26 formed (within the stator slot). The exact number of strip conductor devices is not necessarily important here. It can be seen that all strip conductor devices are designed according to the basic principle of the present disclosure (according to claim 1). In the different embodiment according to FIG. 6, several inner strip conductor devices are formed according to the basic principle of present disclosure (specifically four, which isn't meant to be limiting) and other strip conductor devices (specifically two here) that are further to the outside without corresponding step increments according to the present disclosure. In the present case, specifically two-thirds of the strip conductor devices (which should not be understood as limiting) are designed with step increments in accordance with the present disclosure.

In a further different embodiment according to FIG. 7, only the inner (or innermost) two strip conductor devices are designed with at least one corresponding step increment in accordance with the present disclosure, and the outer ones (here: four) are not. Only one third (which again should not be understood as limiting) of the strip conductor devices is thus designed with at least one step increment according to the present disclosure.

At this point, it should be noted that all parts described above, considered individually and in any combination, in particular the details shown in the drawings, are claimed as essential to the invention. Modifications thereof are familiar to those skilled in the art.

Furthermore, it is pointed out that a scope of protection as broad as possible is sought. In this respect, the disclosure contained in the claims may also be specified by features which are described with further features (even without these further features necessarily being included). It is explicitly pointed out that round brackets and the term ‘in particular’ are intended to emphasise the optional nature of features in the respective context (which does not mean, conversely, that a feature is to be regarded as mandatory in the corresponding context without such indication). The term ‘element’ should preferably denote a respective coherent structure which, in turn, may be connected to at least one other structure (to form a one-piece and/or non-movable overall structure) or may be delimited from all other structures.

### LIST OF REFERENCE SIGNS

1, 2 strip conductor elements
11; 12; 13 strip conductor elements
14 stator
21; 22; 23; 24; 25; 26 strip conductor device

What is claimed is:

1. Strip conductor device designed for use in electrical machines supplied with alternating current, the device comprising. at least two elongated, rigid strip conductor elements with contact devices for coupling to and decoupling from electrical current, wherein the strip conductor elements provide a current path and the strip conductor elements form a layer arrangement with electrical insulation located therebetween, that
wherein the strip conductor elements are stacked one above the other and, over their conductor length, exchange their positions relative to the position in the stack at least once, and furthermore the position exchange is realized without twisting or rotation via complementary step increments of the strip conductors.

2. Strip conductor device according to claim 1,
wherein in the region of the step increments, the cross-sectional area shape of the strip conductor elements varies.

3. Strip conductor device according to claim 2,
wherein in the region of the step increments, the cross-sectional area remains largely constant with varying cross-sectional area shape.

4. Strip conductor device according to claim 3,
wherein the cross-sectional area in the region of the step increments is adapted to the cross-sectional area of the remaining sections of the strip conductor elements.

5. Strip conductor device according to claim 1,
wherein the step increments each have complementary recesses on the width side of the strip conductor elements, which interlock as a result of joining the stack.

6. Strip conductor device according to claim 1,
further comprising a stack arrangement of at least two strip conductor elements each with at least one or at least two step increments (SP), wherein the respective ends of the strip conductor elements are electrically connected.

7. Strip conductor device according to claim 6,
wherein the stack arrangement is adapted in terms of its measurements in length and cross-section to the dimensions of grooves in the stator or core of an electric machine.

8. Strip conductor device according to claim 1,
wherein
it is part of a rectangular coil or a hairpin.

9. Strip conductor device according to claim 1,
wherein the strip conductor elements are stacked flatly narrow, gap-free, densely and with a thin insulating layer interposed between them, and form a compact arrangement.

10. Strip conductor device according to claim 9,
wherein the thickness or layer thickness of the insulating layer is many times smaller than the thickness of the strip conductor elements.

11. Strip conductor device according to claim 1,
wherein the strip conductor elements consist of a solid copper or copper alloy material or are manufactured by means of additive technology.

12. Stator and/or electric machine comprising at least one coil with at least one strip conductor device according claim 1.
